(19) United States
(12) Patent Application Publication
(10) Pub. No.: US 2009/0224693 A1
(43) Pub. Date: Sep. 10, 2009

(54) ILLUMINATION SOURCE, ILLUMINATION SYSTEM, AND DIMMING CONTROL METHOD FOR THE PRODUCTION OF DIFFERENT COLOUR TEMPERATURES

(76) Inventors: Kenji Mukai, Osaka (JP); Hideo Nagai, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 11/720,140

(22) PCT Filed: Nov. 29, 2005
(86) PCT No.: PCT/JP2005/022251

§ 371 Date: May 24, 2007

(30) Foreign Application Priority Data
Dec. 10, 2004 (JP) 2004-358038

(51) Int. Cl. H05B 37/02; F21V 9/00

(52) U.S. Cl. 315/295; 362/231

(57) ABSTRACT

An illumination source 1 is capable of outputting illumination light at different color temperatures, by adjustment of luminous intensity ratios of light emitting devices 3-6, where each of the light emitting devices emits light in a corresponding one of at least four colors, the at least four colors including a first red and a second red that is different from the first red. Accordingly, the illumination source 1 is capable of outputting illumination light at an incandescent lamp color, a neutral white color, and a daylight color, and exhibiting favorable color rendering characteristics for all the three colors.

### TECHNICAL FIELD

The present invention relates to an illumination source, and to an illumination system equipped with the illumination source. The present invention further relates to a dimming control method used in the illumination system.

### BACKGROUND ART

The Japan industrial standard (JIS): Z9112 defines five colors (color temperatures) for illumination light for an illumination source. Among the five colors, an incandescent lamp color (color temperature of 3000K), a neutral white color (color temperature of 5000K), and a daylight color (color temperature of 6700K) are frequently employed for room illumination.

Recently, illumination sources of which illumination light color is variable have been developed (e.g. Published Japanese Translation of a PCT application No. 2003-517705). Such an illumination source is able to alter illumination color easily in accordance with the season and the time of day. For example, it is possible to adopt a daylight color during summer because the color looks cool, while adopting an incandescent lamp color during winter because the color looks warm. On the other hand, it is possible to adopt a daylight color while working because the color is said to help improve the work efficiency, while adopting an incandescent lamp color during a break because the color is relaxing.

One criterion used in evaluation of illumination light quality is a color rendering characteristic. The color rendering characteristic attempts to evaluate illumination light in comparison with the natural light. Specifically, when the color tone of an object upon which illumination light is irradiated is close to that of natural light, the illumination light is evaluated as having a favorable color rendering characteristic. Usually, the color rendering characteristic is represented by a general color rendering index Ra. When the general color rendering index Ra indicates 90 or above, the illumination light is evaluated as having a favorable color rendering characteristic.

Currently, however, there is no illumination source of which illumination light color is variable that has favorable color rendering characteristics for all of an incandescent lamp color, a neutral white color, and a daylight color. For example, when an illumination source exhibits a favorable color rendering characteristic for an incandescent lamp color, it exhibits an unfavorable color rendering characteristic for a daylight color. Conversely, when an illumination source exhibits a favorable color rendering characteristic for a daylight color, it exhibits an unfavorable color rendering characteristic for an incandescent lamp color. This means that if an illumination source is designed to exhibit a favorable color rendering characteristic for illumination light of low color temperatures, it will exhibit an unfavorable color rendering characteristic for illumination light of high color temperatures, and conversely when the illumination source is designed to exhibit a favorable color rendering characteristic for illumination light of high color temperatures, it will exhibit an unfavorable color rendering characteristic for illumination light of low color temperatures.

### DISCLOSURE OF THE INVENTION

In view of the above-stated problem, the present invention aims to provide an illumination source capable of outputting illumination light at an incandescent lamp color, a neutral white color, and a daylight color, and exhibiting favorable color rendering characteristics for all the three colors. The present invention also aims to provide an illumination system equipped with the illumination source, and a dimming control method used in the illumination system.

So as to solve the above-described problem, an illumination source relating to the present invention is an illumination source capable of outputting illumination light at different color temperatures, including: a first light emitting device operable to emit light in a first red; a second light emitting device operable to emit light in a second red that is different from the first red; and a third light emitting device operable to emit light in a different color from the first red and from the second red, and a fourth light emitting device operable to emit light in a different color from any of the first red, the second red, and the color of light emitted from the third light emitting device, where the illumination light is outputted at different color temperatures by adjusting luminous intensity ratios of the first to fourth light emitting devices.

Here, “color temperature” is a value representing a relative strength between blue light and red light contained in an illumination source emitting light of a certain color. The color temperature is represented by a blackbody temperature of a perfect blackbody that emits light of the same color as emitted by the illumination source.

“Luminous intensity ratio” is a ratio of luminous strength of each light emitting device emitting a different one of all the colors with respect to a luminous intensity of the entire illumination source. Therefore, summation of all the luminous intensity ratios of all the light emitting devices will yields 100%.

The illumination source relating to the present invention has at least four light emitting devices that respectively emit a different one of colors, including two types of red. Therefore, it is possible to generate illumination light having a targeted color temperature by selecting one of the two types of red that is more suitable for generating illumination light having a favorable color rendering characteristic, thereby mixing the selected type of red with the other colors of light. Accordingly, the illumination source of the present invention is capable of outputting illumination light at the incandescent lamp color, the neutral white color, and the daylight color, and also to obtain favorable color rendering characteristics for all the three colors.

### BRIEF DESCRIPTION OF THE DRAWINGS

FIG. 1 is a perspective diagram showing an embodiment of an illumination source relating to the present invention.

FIG. 2 is a plan view showing an overview of an illumination source relating to a modification example 1.

FIG. 3 is a plan view showing an overview of an illumination source relating to a modification example 2.

FIG. 4 is a plan view showing an overview of an illumination source relating to a modification example 3.

FIG. 5 is a diagram showing light emission spectrums respectively for a first red light emitting device and a second red light emitting device.

FIG. 6 is a diagram showing a light emission spectrum for a blue light emitting device.

FIG. 7 is a diagram showing a light emission spectrum for a white light emitting device.

FIG. 8 is a partly-broken perspective diagram showing an embodiment of an illumination system relating to the present invention.

FIG. 9 is a diagram drawn to explain how the illumination source and the lighting apparatus are connected to each other.

FIG. 10 is a diagram drawn to explain how an illumination source and a lighting apparatus are connected to each other in an illumination system relating to a modification example.

FIG. 11 shows a light emission spectrum of illumination light for an incandescent lamp color.

FIG. 12 shows a light emission spectrum of illumination light for a neutral white color.

FIG. 13 shows a light emission spectrum of illumination light of a-daylight color.

FIG. 14 shows a result of measuring, by way of simulation, the general color rendering index Ra for illumination light generated by mixing red light, blue light, and green light.

FIG. 15 shows a general color rendering index Ra for a case where light having a particular peak wavelength is mixed with illumination light having an incandescent lamp color.

FIG. 16 shows a general color rendering index Ra for a case where light having a particular peak wavelength is mixed with illumination light having a neutral white color.

FIG. 17 shows a general color rendering index Ra for a case where light having a particular peak wavelength is mixed with illumination light having a daylight color.

FIG. 18 is a diagram showing general color rendering indices Ra of illumination sources.

FIG. 19 is a diagram showing, for each light emitting device, how the luminous intensity ratio is related to the general color rendering index Ra.

### BEST MODE FOR CARRYING OUT THE INVENTION

As follows, an illumination source, an illumination system, and a dimming control method, which relate to the present invention, are described by way of an embodiment and with reference to the drawings.

<Illumination Source>

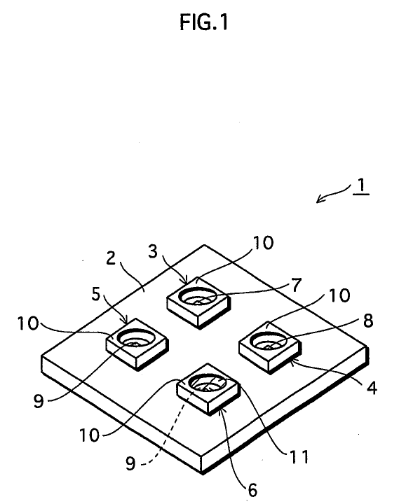

FIG. 1 is a perspective diagram showing an embodiment of an illumination source relating to the present invention. As shown in FIG. 1, an illumination source 1 relating to the present embodiment includes: a multilayer printed wiring board 2 (hereinafter simply “printed wiring board 2”); and four light emitting devices 3-6 respectively emitting light in different colors, the light emitting devices 3-6 being provided on the printed wiring board 2.

The light emitting devices 3-6 are specifically: a first red light emitting device 3 that emits light in a first red; a second red light emitting device 4 that emits light in a second red; a blue light emitting device 5 that emits light in blue; and a white light emitting device 6 that emits light in white. The light emitting devices 3-6 are arranged with an appropriate distance therebetween so that rays of light emitted from the light emitting devices 3-6 will be mixed to generate white illumination light.

Note that among these colors of light emitted from the light emitting devices 3-6, the two colors other than the two types of red (i.e. other than the first red and the second red) are not limited to blue and white, as long as white illumination light will result by mixture of all the light of colors emitted from the light emitting devices 3-6. Other possible combinations are: a combination of blue, green, and two types of red; a combination of blue, yellow, and two types of red, and so forth.

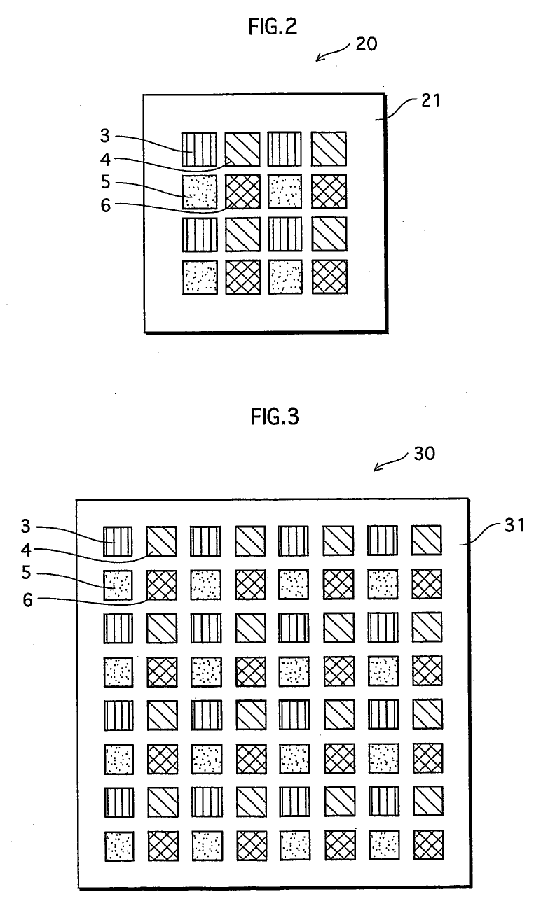

It should be also noted that the number of the light emitting devices 3-6 is not limited to one for each color. FIGS. 2-4 respectively illustrate a plan view showing an overview of an illumination source relating to a modification example. Just as an illumination source 20 shown in FIG. 2, for example, it is possible to provide a printed wiring board 21 with four sets of first red light emitting device 3, second red light emitting device 4, blue light emitting device 5, and white light emitting device 6. Furthermore, just as an illumination source 30 shown in FIG. 3, it is also possible to provide a printed wiring board 31 with sixteen sets of first red light emitting device 3, second red light emitting device 4, blue light emitting device 5, and white light emitting device 6.

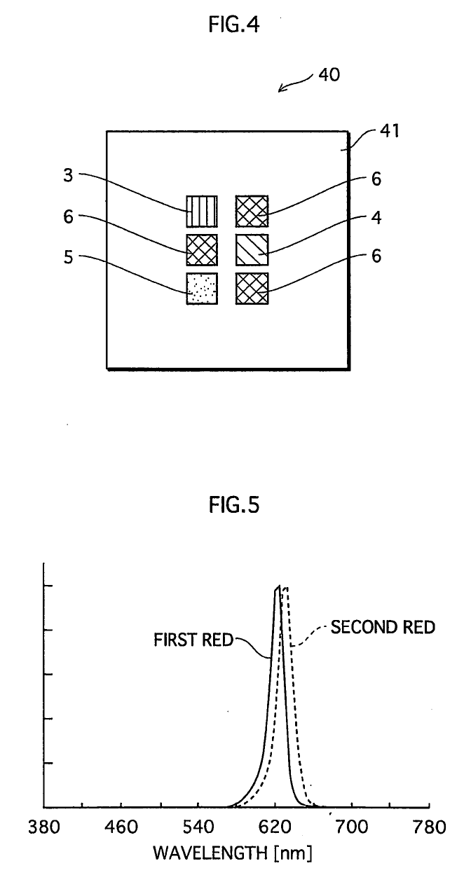

Furthermore, it is not necessary that the light emitting devices 3-6 are provided in the same number for each of the colors. For example, just as an illumination source 40 shown in FIG. 4, it is possible to provide a printed wiring board 41 with more white light emitting devices 6 than the other light emitting devices 3-5 in number. The white light emitting device 6 is set to have a higher luminous intensity ratio than that of the other light emitting devices 3-5, regardless of the intended color of the illumination light, i.e. whether the intended color is an incandescent lamp color, a neutral white color, or a day light color. Therefore by increasing the number of the white light emitting devices 6, the illumination light tends to have enhanced luminous intensity.

Note that generally, the distance from the illumination source 1 to an object of illumination is much longer than the distance between the light emitting devices 3-6. Therefore the rays of light from the light emitting devices 3-6 will be mixed without particular attention paid to the distance between the light emitting devices 3-6 or to the arrangement of the light emitting devices 3-6. However from a manufacturing point of view and so forth, it is desirable that the light emitting devices 3-6 be aligned regularly to some extent.

As FIG. 1 shows, each of the light emitting devices 3-6 is provided with a corresponding one of the LEDs 7-9 and a reflection member 10. Note that the LEDs 7-9 may adopt several types such as a lamp-type LED from which lead wire extends and a chip-type LED being a chip component.

The first red light emitting device 3 is provided with a first red LED 7 having a light emission peak wavelength of 625 nm. The light emitted from the first red light emitting device 3 has a light emission spectrum as shown by a solid line in FIG. 5. Note that the light emission peak wavelength of the first red light emitting device 3 is not limited to 625 nm, as long as it lies within the range of 610-700 nm, and is different from the light emission peak wavelength of the second red light emitting device 4. It is desirable, however, that the light emission peak wavelength of the first red light emitting device 3 lies within the range of 620-630 nm, for the purpose of generating illumination light having a high general color rendering index Ra.

The second red light emitting device 4 is provided with a second red LED 8 having a light emission peak wavelength of 635 nm. The light emitted from the second light emitting device 4 has a light emission spectrum as shown by a broken line in FIG. 5. Note that the light emission peak wavelength of the second red light emitting device 4 is not limited to 635 nm, as long as it lies within the range of 610-700 nm, and is different from the light emission peak wavelength of the first red light emitting device 3. It is desirable, however, that the light emission peak wavelength of the second red light emitting device 4 lies within the range of 630-640 nm, for the purpose of generating illumination light having a high general color rendering index Ra.

The blue light emitting device 5 is provided with a blue LED 9 having a light emission peak wavelength of 460 nm. The light emitted from the blue light emitting device 5 has a light emission spectrum as shown in FIG. 7. Note that the light emission peak wavelength is not limited to 460 nm, as long as it lies within the range of 455-465 nm.

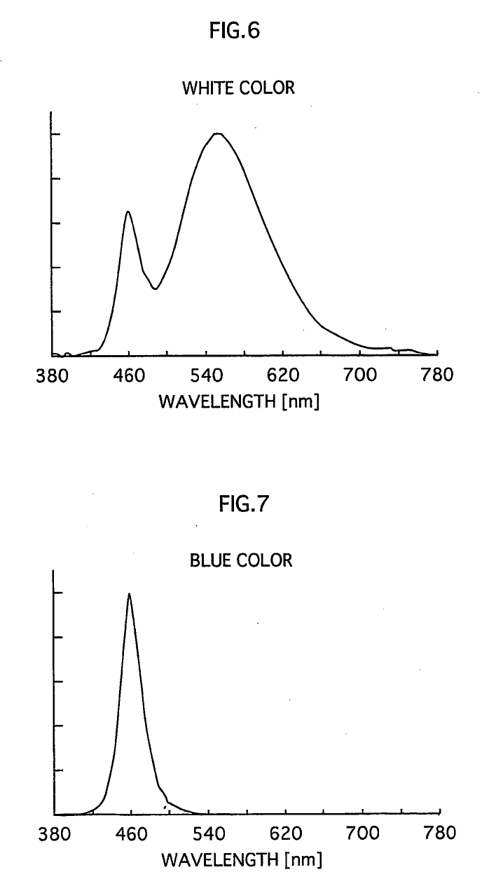

The white light emitting device 6 is provided with: a blue LED 9 having a light emission peak wavelength of 460 nm (same type as used for the blue light emitting device 5); and a green phosphor 11 provided to cover the blue LED 9, the green phosphor 11 having a light emission peak wavelength of 550 nm. In the white light emitting device 6, part of the blue light emitted from the blue LED 9 is converted to green light by means of the green phosphor 11. The rest of the blue light left unconverted is mixed with the green light resulting from the conversion, to generate white light having a light emission spectrum as shown in FIG. 6.

Note that the blue LED 9 used for the white light emitting device 6 may have a different light emission peak wavelength from that of the blue LED 9 of the blue light emitting device 5. In addition, the light emission peak wavelength of the blue LED 9 used for the white light emitting device 6 is not limited to 460 nm, as long as it lies within the range of 455-465 nm. Furthermore, the light emission peak wavelength of the green phosphor 11 is not limited to 550 nm, as long as it lies within the range of 545-555 nm.

In addition, the colors of light emitted from the LED and the phosphor used for the white light emitting device 6 are not limited to a combination of blue and green respectively, as long as they can generate white light by being mixed. For example, other possible combinations are: a blue LED and a red phosphor that is capable of converting the blue light emitted from the blue LED into red light; and a blue LED and a yellow phosphor that is capable of converting the blue light emitted from the blue LED into yellow light.

The illumination source 1 having the above structure is able to vary the color of illumination light as appropriate, by adjustment of the luminous intensity ratio for each of the light emitting devices 3-6 with use of the lighting apparatus detailed later, or with use of various other lighting apparatuses.

<Illumination System>

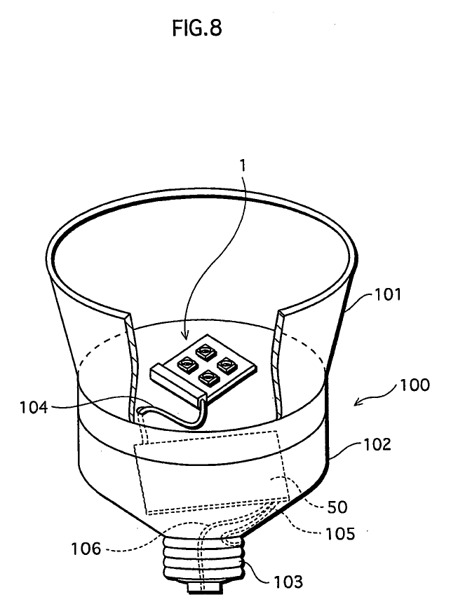

FIG. 8 is a partly-broken perspective diagram showing an embodiment of an illumination system relating to the present invention. An illumination system 100 is used as an alternative to a general incandescent lamp. As FIG. 8 shows, the illumination system 100 includes: an illumination source 1; a reflection shade 101 for guiding the light from the illumination source 1 forward (upper direction in the drawing) by reflecting the light; a lighting apparatus 50 for causing the light emitting devices 3-6 in the illumination source 1 to emit light; a case 102 for storing therein the lighting apparatus 50; and a base 103 being the same size (same standard) as that used for the general incandescent lamp.

The lighting apparatus 50 is connected to the illumination source 1 via a lead wire 104, and also to the base 103 via lead wires 105 and 106. The lighting apparatus 50 supplies electric current inputted from an external commercial alternating power source (not shown in the drawing) to the illumination source 1 via the base 103.

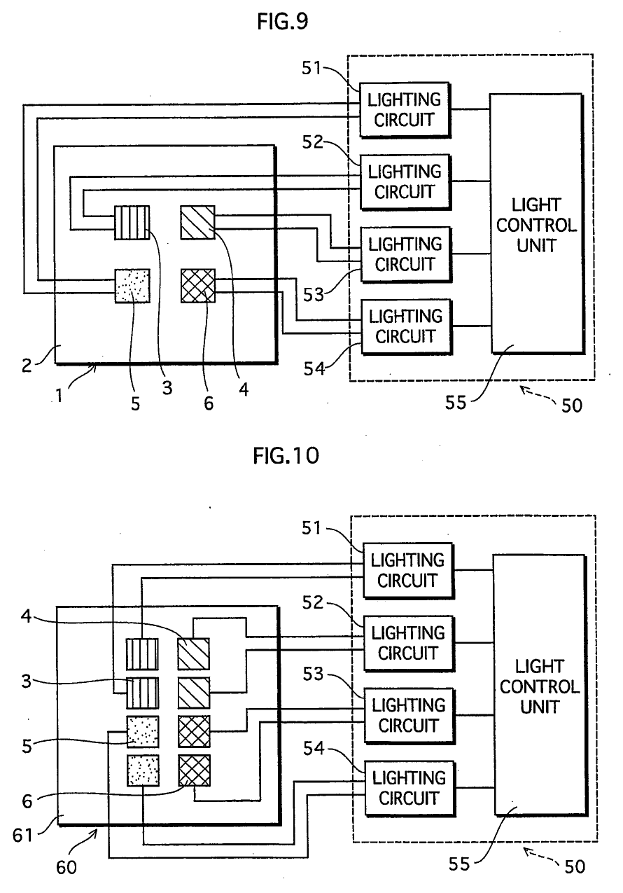

FIG. 9 is a diagram drawn to explain how the illumination source and the lighting apparatus are connected to each other. FIG. 10 is a diagram drawn to explain how an illumination source and a lighting apparatus are connected to each other in an illumination system relating to a modification example. As FIG. 9 shows, the lighting apparatus 50 is equipped with: four lighting circuits 51-54 respectively corresponding to the light emitting devices 3-6; and a light control unit 55 for controlling the lighting circuits 51-54.

The lighting circuit 51 is connected to the first red light emitting device 3 via a wiring pattern (not shown in the drawing) of the printed wiring board 2. The lighting circuit 51 supplies power to the first red light emitting device 3 to cause the device 3 to emit light.

The lighting circuit 52 is connected to the second red light emitting device 4 via a wiring pattern (not shown in the drawing) of the printed wiring board 2. The lighting circuit 52 supplies power to the second red light emitting device 4 to cause the device 4 to emit light.

The lighting circuit 53 is connected to the blue light emitting device 5 via a wiring pattern (not shown in the drawing) of the printed wiring board 2. The lighting circuit 53 supplies power to the blue light emitting device 5 to cause the device 5 to emit light.

The lighting circuit 54 is connected to the white light emitting device 6 via a wiring pattern (not shown in the drawing) of the printed wiring board 2. The lighting circuit 54 supplies power to the blue light emitting device 6 to cause the device 6 to emit light.

The light control unit 55 is connected to the lighting circuits 51-54. The light control unit 55 controls power supply from the lighting circuits 51-54 to the light emitting devices 3-6, thereby adjusting the luminous intensity ratios of the light emitting devices 3-6. Note that the mentioned control performed by the light control unit 55 includes a case of controlling any of the luminous intensity ratios down to 0% thereby completely stopping illumination of a corresponding one of the light emitting devices 3-6.

FIG. 10 shows an illumination source 60 in which several sets of light emitting devices 3-6 are provided on a printed wiring board 61. In this case, of the light emitting devices 3-6, light emitting devices having a same color are connected in series first and then are connected to a corresponding one of the lighting circuits 51-54.

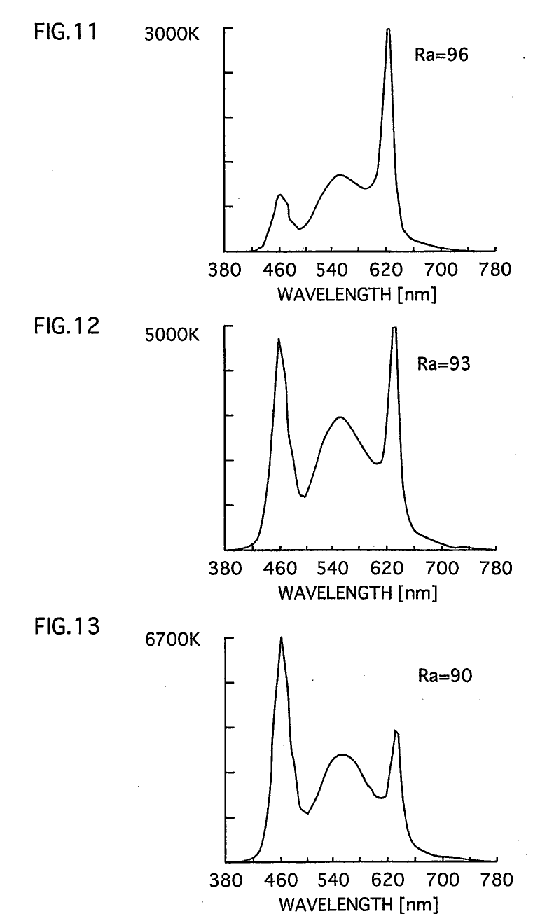

FIG. 11 shows a light emission spectrum of illumination light for an incandescent color. FIG. 12 shows a light emission spectrum of illumination light for a neutral white color. FIG. 13 shows a light emission spectrum of illumination light of a daylight color.

The illumination system 100, having the above structure, is able to generate illumination light of an incandescent lamp color having a general color rendering index Ra of 95 and having the light emission spectrum as shown in FIG. 11, if the luminous intensity ratios are set as follows: 22.1% for the first red light emitting device 3; 0% for the second red light emitting device 4; 0.6% for the blue light emitting device 5; and 77.3% for the white light emitting device 6.

On the other hand, if the luminous intensity ratios are set as follows: 0% for the first red light emitting device 3; 9.5% for the second red light emitting device 4; 2.9% for the blue light emitting device 5; and 87.6% for the white light emitting device 6, then the illumination system 100 is able to generate illumination light of a neutral white color having a general color rendering index Ra of 93 and having the light emission spectrum as shown in FIG. 12.

Furthermore, if the luminous intensity ratios are set as follows: 0% for the first red light emitting device 3; 6.3% for the second red light emitting device 4; 4.7% for the blue light emitting device 5; and 89.0% for the white light emitting device 6, then the illumination system 100 is able to generate illumination light of a daylight color having a general color rendering index Ra of 90 and having the light emission spectrum as shown in FIG. 13.

It is also possible to generate illumination light by causing the first red light emitting device 3 and the second red light emitting device 4 to emit light simultaneously. For example, if the luminous intensity ratios are set as follows: 16% for the first red light emitting device 3; 5% for the second red light emitting device 4; 1% for the blue light emitting device 5; and 78% for the white light emitting device 6, then the illumination system 100 is able to generate illumination light of an incandescent lamp color having a general color rendering index Ra of 96.

<Dimming Control Method for the Illumination System>

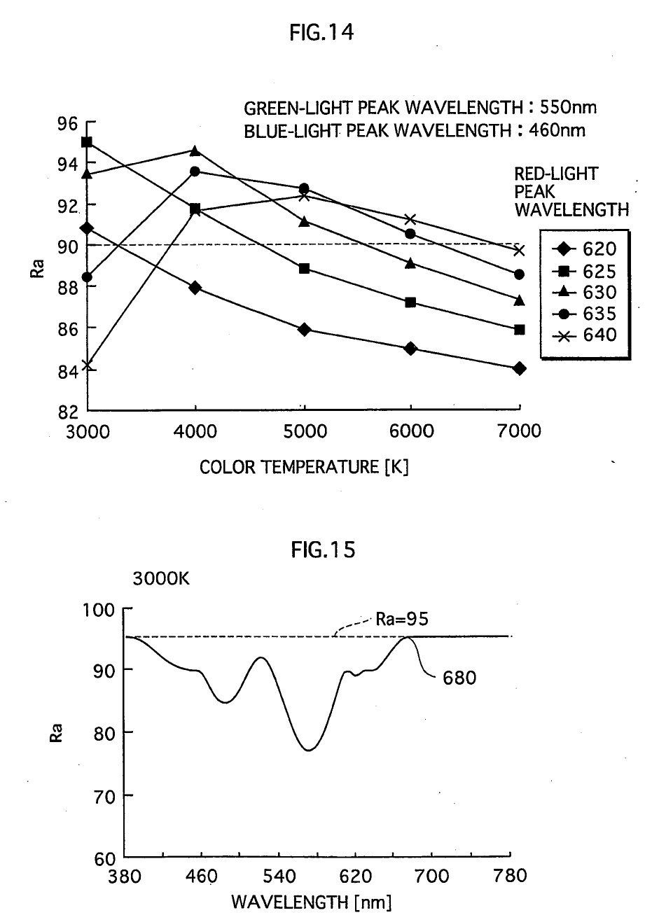

FIG. 14 shows a result of measuring, by way of simulation, the general color rendering index Ra for illumination light generated by mixing red light, blue light, and green light.

In the simulation, the light emission peak wavelength for red light was set to 620 nm, 625 nm, 630 nm, 635 nm, and 640 nm. In addition, the light emission peak wavelength for blue light was set to 460 nm, and the light emission peak wavelength for green light was set to 550 nm.

The general color rendering index Ra was measured for the cases where the color temperatures are 3000K, 4000K, 5000K, 6000K, and 7000K, respectively.

As shown in FIG. 14, for the case of an incandescent lamp color (i.e. color temperature of 3000K), when the light emission peak wavelength for red light is set to 635 nm or to 640 nm, the general color rendering index Ra results in less than 90. On the other hand, for the case of a neutral white color (i.e. color temperature of 5000K), when the light emission peak wavelength for red light is set to 620 nm or to 625 nm, the general color rendering index Ra results in less than 90. Furthermore, for the case of a daylight color (i.e. color temperature of 6700K), when the light emission peak wavelength for red light is set to any one of 620 nm, 625 nm, 630 nm, and 635 nm, the general color rendering index Ra results in less than 90.

From this simulation result, it turns out that, if using only one kind of red light, it is difficult to obtain general color rendering index Ra of 90 or above for all the incandescent lamp color, the neutral white color, and the daylight color. However if two kinds of red light are used instead (specifically, by using red light having a light emission peak wavelength of 620-630 nm for the incandescent lamp color; and by using red light having a light emission peak wavelength of 630-640 nm for the daylight color), it is possible to obtain general color rendering index Ra of 90 or above for all the incandescent lamp color, the neutral white color, and the daylight color.

Therefore, it can be said that two kinds of red light are necessary for obtaining general color rendering index Ra of 90 or above for all the incandescent lamp color, the neutral white color, and the daylight color.

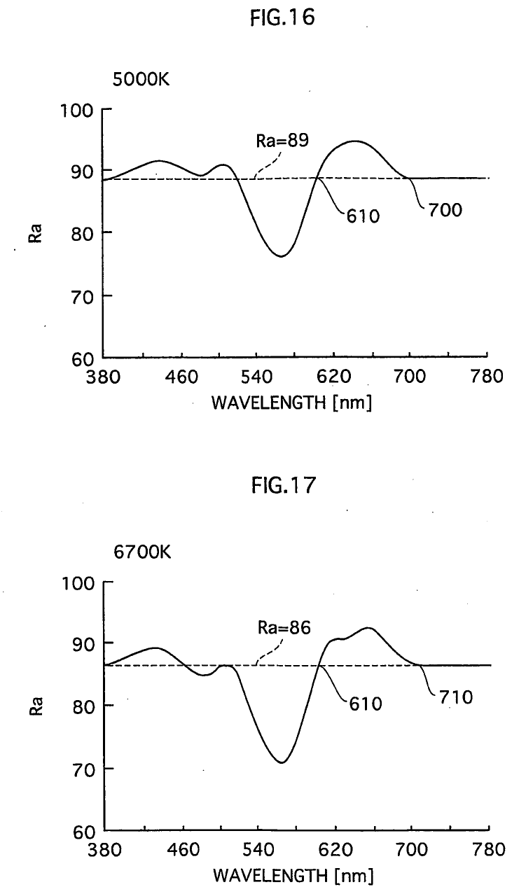

FIG. 15 shows a general color rendering index Ra for a case where light having a particular peak wavelength is mixed with illumination light having an incandescent lamp color. FIG. 16 shows a general color rendering index Ra for a case where light having a particular peak wavelength is mixed with illumination light having a neutral white color. FIG. 17 shows a general color rendering index Ra for a case where light having a particular peak wavelength is mixed with illumination light having a daylight color.

As shown in FIG. 15, the general color rendering index Ra is 95 for illumination light having an incandescent lamp color, which is generated by mixing red light having a light emission peak wavelength of 625 nm, blue light having a light emission peak wavelength of 460 nm, and green light having a light emission peak wavelength of 550 nm. If light having a peak wavelength in the range of 380-780 nm is mixed with the above-mentioned illumination light having an incandescent lamp color, the general color rendering index Ra changes as shown in FIG. 15. As is clear from FIG. 15, if light having any wavelength is mixed with the illumination light having an incandescent lamp color, the general color rendering index Ra will never exceed 95. This means that it is not necessary to use any second red light in the case of incandescent lamp color.

As shown in FIG. 16, the general color rendering index Ra is 89 for illumination light having a neutral white color, which is generated by mixing red light having a light emission peak wavelength of 625 nm, blue light having a light emission peak wavelength of 460 nm, and green light having a light emission peak wavelength of 550 nm. If light having a peak wavelength in the range of 380-780 nm is mixed with the above-mentioned illumination light having a neutral white color, the general color rendering index Ra changes as shown in FIG. 16. As is clear from FIG. 16, if light having wavelength within the range of 610-700 nm is mixed with the illumination light having a neutral white color, the general color rendering index Ra will exceed 89 being the original value. This means that it is effective to mix a second red light having a light emission peak wavelength within the range of 610-700 nm, for enhancing the general color rendering index Ra in the case of neutral white color.

As shown in FIG. 17, the general color rendering index Ra is 86 for illumination light having a daylight color, which is generated by mixing red light having a light emission peak wavelength of 625 nm, blue light having a light emission peak wavelength of 460 nm, and green light having a light emission peak wavelength of 550 nm. If light having a peak wavelength in the range of 380-780 nm is mixed with the above-mentioned illumination light having a daylight color, the general color rendering index Ra changes as shown in FIG. 17. As is clear from FIG. 17, if light having wavelength within the range of 610-710 nm is mixed with the illumination light having a neutral white color, the general color rendering index Ra will exceed 86 being the original value. This means that it is effective to mix a second red light having a light emission peak wavelength within the range of 610-710 nm, for enhancing the general color rendering index Ra in the case of daylight color.

From the above discussion, it can be said that if a second red light having a light emission peak wavelength within the range of 610-700 nm is mixed with illumination light generated by mixing red light, blue light, and green light, it is effective for obtaining favorable color rendering characteristics for all the incandescent lamp color, the neutral white color, and the daylight color.

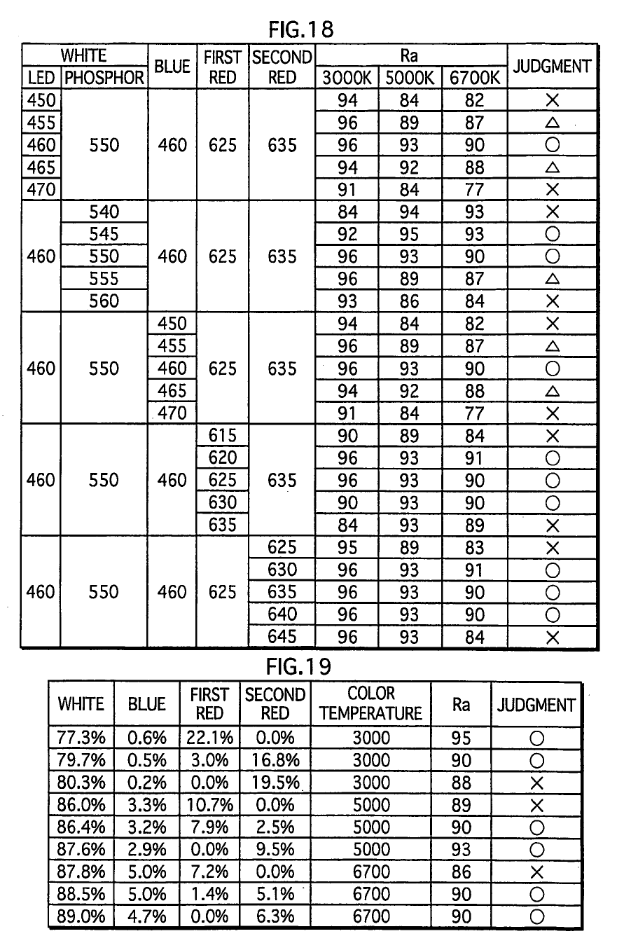

Such an illumination source was actually produced, and the general color rendering index Ra of illumination light outputted by the illumination source was measured. The result is shown in FIG. 18.

First, the general color rendering index Ra of illumination light outputted from an illumination source 1 was measured, where the illumination source 1 is equipped with: a first red light emitting device 3 having a first red LED 7 whose light emission peak wavelength is 625 nm; a second red light emitting device 4 having a second red LED 8 whose light emission peak wavelength is 635 nm; a blue light emitting device 5 having a blue LED 9 whose light emission peak wavelength is 460 nm; and white light emitting device 6 having a blue LED 9 whose light emission peak wavelength is 460 nm and a green phosphor 11 whose light emission peak wavelength is 550 nm.

Further, by changing the light emission peak wavelength of the LEDs 7-9 and the green phosphor 11 one by one, the general color rendering index Ra of illumination light emitted from the illumination source was measured.

As shown in the judgment column of FIG. 18, any illumination source exhibiting the general color rendering index Ra of 90 or above for all the three colors of incandescent lamp color, neutral white color, and daylight color is judged favorable (shown by the sign “o” in the drawing). Any illumination source that cannot be judged favorable, but still exhibits the general color rendering index Ra of 85 or above for all the three colors is judged fair (shown by the sign “a” in the drawing). Further, any illumination source that exhibits the general color rendering index Ra of less than 85 for any of the three colors is judged unfavorable (shown by the sign “x” in the drawing).

As described earlier, it is preferable to obtain a color rendering index Ra of 90 or above. However, if an illumination source exhibits the general color rendering index Ra of 85 or above, then the value is modifiable to 90 or above by changing the light emission peak wavelength of any of the LEDs 7-9 and the green phosphor 11. For example, when the blue LED 9 of the white light emitting device 6 has alight emission peak wavelength of 455 nm, the general color rendering index Ra is 89 for a neutral white color (color temperature of 5000K). However in this case, the value of 89 was modified to 90 or above successfully, by changing the light emission peak wavelength of the LEDs 7-9 of the first red light emitting device 3, the second red light emitting device 4, and the blue light emitting device 5.

Accordingly, it can be said that the general color rendering index Ra will be 90 or above for all the three colors of incandescent lamp color, neutral white color, and daylight color, if the following five conditions are satisfied.

(Five Conditions)
1. Light emission peak wavelength of the first red LED 7 of the first red light emitting device 3 is set within the range of 620-630 nm.
2. Light emission peak wavelength of the second red LED 8 of the second red light emitting device 4 is set within the range of 630-640 nm.
3. Light emission peak wavelength of the blue LED 9 of the blue light emitting device 5 is set within the range of 455-465 nm.
4. Light emission peak wavelength of the blue LED 9 of the white light emitting device 6 is set within the range of 455-465 nm.
5. Light emission peak wavelength of the green phosphor 11 of the white light emitting device 6 is set within the range of 545-555 nm.

Next, by changing the luminous intensity ratio of each of the light emitting devices 3-6 to various values, the general color rendering index Ra of illumination light generated by the illumination source 1 was measured. The result is shown in FIG. 19.

As shown in the judgment column of FIG. 19, if the general color rendering index Ra shows 90 or above, then corresponding illumination light is judged favorable (shown by the sign “o” in the drawing). If the general color rendering index Ra shows less than 90, then corresponding illumination light is judged unfavorable (shown by the sign “x” in the drawing).

If the luminous intensity ratio of each of the light emitting devices 3-6 is adjusted to the range judged favorable (shown by the sign “o” in the drawing), resulting illumination light will have 90 or more of the general color rendering index Ra of illumination light.

Specifically, for illumination light having an incandescent lamp color, the general color rendering index Ra of 90 or above is obtained if the following conditions are satisfied, namely: the luminous intensity ratio for the first red light emitting device 3 lies within the range of 3.0-22.1%; the luminous intensity ratio for the second red light emitting device 4 lies within the range of 0-16.8%; the luminous intensity ratio for the blue light emitting device 5 lies within the range of 0.5-0.6%; and the luminous intensity ratio for the white light emitting device 6 lies within the range of 77.3-79.7%.

Furthermore, for illumination light having a neutral white color, the general color rendering index Ra of 90 or above is obtained if the following conditions are satisfied, namely: the luminous intensity ratio for the first red light emitting device 3 lies within the range of 0-7.9%; the luminous intensity ratio for the second red light emitting device 4 lies within the range of 2.5-9.5%; the luminous intensity ratio for the blue light emitting device 5 lies within the range of 2.9-3.2%; and the luminous intensity ratio for the white light emitting device 6 lies within the range of 86.4-87.6%.

Still Further, for illumination light having a daylight color, the general color rendering index Ra of 90 or above is obtained if the following conditions are satisfied, namely: the luminous intensity ratio for the first red light emitting device 3 lies within the range of 0-1.4%; the luminous intensity ratio for the second red light emitting device 4 lies within the range of 5.1-6.3%; the luminous intensity ratio for the blue light emitting device 5 lies within the range of 4.7-5.0%; and the luminous intensity ratio for the white light emitting device 6 lies within the range of 88.5-89.0%.

### INDUSTRIAL APPLICABILITY

An illumination source, an illumination system, and a dimming control method, which relate to the present invention, are applicable for such purposes as indoor illumination, outdoor illumination, and illumination for image reading.

1. An illumination source capable of outputting illumination light at different color temperatures, comprising:
a first light emitting device operable to emit light in a first red;
a second light emitting device operable to emit light in a second red that is different from the first red; and
a third light emitting device operable to emit light in a different color from the first red and from the second red, and
a fourth light emitting device operable to emit light in a different color from any of the first red, the second red, and the color of light emitted from the third light emitting device, wherein
the illumination light is outputted at different color temperatures by adjusting luminous intensity ratios of the first to fourth light emitting devices.

2. The illumination source of claim 1, wherein
the first light emitting device and the second light emitting device respectively have light emission peak wavelengths within a range of 610 nm to 700 nm, inclusive.

3. The illumination source of claim 1, wherein
the first light emitting device has a light emission peak wavelength within a range of 620 nm to 630 nm, inclusive, and the second light emitting device has a light emission peak wavelength within a range of 630 nm to 640 nm, inclusive.

4. The illumination source of claim 1, wherein
each of the first to fourth light emitting devices has an LED.

5. The illumination source of claim 2, wherein
each of the first to fourth light emitting devices has an LED.

6. The illumination source of claim 3, wherein
each of the first to fourth light emitting devices has an LED.

7. An illumination source capable of outputting illumination light at different color temperatures, comprising:
a first red light emitting device having a first red LED whose light emission peak wavelength lies within a range of 620 nm to 630 nm, inclusive;
a second red light emitting device having a second red LED whose light emission peak wavelength lies within a range of 630 nm to 640 nm, inclusive;
a blue light emitting device having a blue LED whose light emission peak wavelength lies within a range of 455 nm to 465 nm, inclusive; and
a white light emitting device having a blue LED whose light emission peak wavelength lies within a range of 455 nm to 465 nm, inclusive, and a green phosphor whose light emission peak wavelength lies within a range of 545 nm to 555 nm, inclusive, the white light emitting device generating white light by mixing blue light emitted from the blue LED and green light emitted from the green phosphor, wherein
the illumination light is outputted at different color temperatures by adjusting luminous intensity ratios of the first red light emitting device, the second red light emitting device, the blue light emitting device, and the white light emitting device.

8. An illumination system comprising:
an illumination source of claim 1; and
a lighting apparatus operable to control power to the first to fourth light emitting devices, respectively, thereby causing the first to fourth light emitting devices to emit light in respective luminous intensities.

9. An illumination system comprising:
an illumination source of claim 7; and
a lighting apparatus operable to control power to the first red light emitting device, the second red light emitting device, the blue light emitting device, and the white light emitting device, respectively, thereby causing the first red light emitting device, the second red light emitting device, the blue light emitting device, and the white light emitting device to emit light in respective luminous intensities.

10. An illumination system comprising:
an illumination source of claim 7; and
a lighting apparatus operable to control power to the first red light emitting device, the second red light emitting device, the blue light emitting device, and the white light emitting device, respectively, thereby causing the first red light emitting device, the second red light emitting device, the blue light emitting device, and the white light emitting device to emit light in respective luminous intensities, wherein
so as to cause the illumination light to have a color temperature of 3000K, the lighting apparatus adjusts: the first red light emitting device to have a luminous intensity ratio within a range of 3.0% to 22.1%, inclusive; the second red light emitting device to have a luminous intensity ratio within a range of 0% to 16.8%, inclusive; the blue light emitting device to have a luminous intensity ratio within a range of 0.5% to 0.6%, inclusive; and the white light emitting device to have a luminous intensity ratio within a range of 77.3% to 79.7%, inclusive,
so as to cause the illumination light to have a color temperature of 5000K, the lighting apparatus adjusts: the first red light emitting device to have a luminous intensity ratio within a range of 0% to 7.9%, inclusive; the second red light emitting device to have a luminous intensity ratio within a range of 2.5% to 9.5%, inclusive; the blue light emitting device to have a luminous intensity ratio within a range of 2.9% to 3.2%, inclusive; and the white light emitting device to have a luminous intensity ratio within a range of 86.4% to 87.6%, inclusive,
so as to cause the illumination light to have a color temperature of 6700K, the lighting apparatus adjusts: the first red light emitting device to have a luminous intensity ratio within a range of 0% to 1.4%, inclusive; the second red light emitting device to have a luminous intensity ratio within a range of 5.1% to 6.3%, inclusive; the blue light emitting device to have a luminous intensity ratio within a range of 4.7% to 5.0%, inclusive; and the white light emitting device to have a luminous intensity ratio within a range of 88.5% to 89.0%, inclusive.

11. A dimming control method used in an illumination system, the illumination system including an illumination source and a lighting apparatus, the illumination source capable of outputting illumination light at different color temperatures by adjustment of luminous intensity ratios of a plurality of light emitting devices, and the lighting apparatus being operable to control power to the light emitting devices respectively thereby causing the light emitting devices to emit light in respective luminous intensities, wherein
each of the light emitting devices emits light in a corresponding one of at least four colors, the at least four colors including a first red and a second red that is different from the first red.
